(19) United States
(12) Patent Application Publication
(10) Pub. No.: US 2005/0126093 A1
(43) Pub. Date: Jun. 16, 2005

(54) Method of providing a joint between a plate member and a frame profile, and a frame structure comprising such a joint

(76) Inventors: Christian Hedager Wagner, Norre Snede (DK); Per Henrik Gregersen, Ostbirk (DK)

Correspondence Address: MEREK, BLACKMON & VOORHEES, LLC, 673 S. WASHINGTON ST, ALEXANDRIA, VA, 22314, US

(21) Appl. No.: 10/507,900

(22) PCT Filed: Mar. 19, 2003
(86) PCT No.: PCT/DK03/00186

(30) Foreign Application Priority Data
Mar. 20, 2002 (DK) PA 2002 00430

(51) Int. Cl. E06B 3/30; E04G 21/00

(52) U.S. Cl. 52/204.53; 52/200; 52/310; 156/314

(57) ABSTRACT

The invention relates to a method of providing a joint between a plate member (1) and a frame profile (2) with a free edge (8) at the surface of the plate member. The joint is provided by applying two adhesives (9, 10). A first adhesive which, only after a curing time, obtains sufficient bearing capacity to support the plate member, is arranged on one of the surfaces to be connected by the joint, such that the adhesive (9) in the assembled condition will be placed close to said free edge. A second adhesive (10) which, immediately or shortly after, compared to the curing time of the first adhesive, obtains sufficient bearing capacity to keep the plate member in place, is arranged between said first adhesive and the free edge of the profile. The second adhesive (10) fits so tightly to plate member and profile that it prevents the first adhesive (9) from forcing its way past the free edge (8) of the profile. Further, the invention relates to a frame structure comprising such a joint.

The invention relates to a method of providing a joint between a plate member and a frame profile, where an adhesive which obtains its bearing capacity only after a curing time, is arranged on at least one of the surfaces to be connected by the joint, such that the adhesive in the assembled condition will be placed close to a free edge of the profile. The invention further relates to a frame structure comprising such a joint.

A window with a joint obtained in this way is known from among other U.S. Pat. No. 6,286,267 disclosing a roof window in which the pane in the closed position directly abuts gasket profiles in a frame member. The L-shaped sash profile with the longer leg at right angles to the roof surface covers the edge of the pane and extends down over the top portion of the frame profile, whereas the shorter leg overlaps the edge of the pane and at its outer free edge is bent down against the surface of the pane, a cavity being formed below the sash profile at the top side of the pane. The pane is fastened to the sash profile by a seam arranged in this cavity.

A considerable inconvenience of this and similar methods is that the generally used sealants have a curing time of about 3-4 hours in order to obtain such strength that the work can be resumed on the frame structure in which the joint is used. Alternatively, mechanical retaining means must be used to keep the plate member in place; however, the method is thus made difficult and more expensive.

Therefore, the main object of the invention is to provide a method of the initially stated kind, by which it is possible to mount or to work in another way with the frame profile immediately or shortly after the plate member has been secured thereto.

This and other objects are obtained by a method according the invention, in which close to said first adhesive and between the plate member and the profile, a second adhesive is arranged to obtain its bearing capacity immediately or shortly after, compared to the curing time of the first adhesive. The adhesion is thus a two-stage process in which the second adhesive supports the plate member until the first adhesive has obtained sufficient strength. When the first adhesive has cured sufficiently in order to obtain essentially its final strength, the second adhesive has completed its function; in principle, its strength durability is of minor importance.

In a preferred embodiment, the second adhesive is applied between said first adhesive and said free edge of the profile. A protection is thus obtained of the first adhesive being inserted relatively far below the protecting profile and external loads being to some extent impeded by the second adhesive.

In a preferred embodiment, the second adhesive is applied as to fit so tightly to the plate member that it prevents the first adhesive from forcing its way past the free edge of the profile. Thereby, another inconvenience of the prior art is avoided; the joint sealant is frequently seen passing through the slit generally provided between the plate member and the free edge of the profile. If such extrusions or “tongues” are not removed or not thoroughly removed, they may after some time be loosened from the plate member as a consequence of various environmental impacts, and the extrusions may result in leaks when detaching the seam itself.

The preferred embodiment prevents the adhesive from forcing its way out on the portion of the plate member which is visible in the mounted condition. Thus, a joint is obtained which is both more durable and more advantageous for aesthetic reasons. If, at the same time, a sufficiently high adhesive path is used, the bending of the free edge of the profile mentioned in connection with prior art is rendered superfluous, the profile shaping being simplified.

In an appropriate embodiment, the second adhesive is provided in the form of a seam or a tape. These two ways of application assure a well defined adhesion, both the contact surface area between the adhesive and the surfaces to be connected, and the extent in the plane of the plate member being controllable relatively precisely as compared to an adhesive being applied e.g. by a brush. Furthermore, a relatively high and narrow path of the adhesive can be obtained which is an advantage in particular if the distance varies between the profile and the plate member.

If there is no need for sealing properties of the second adhesive, it may be an advantage that the second adhesive is applied such that along the joint, there will be points or pieces where one or more of the surfaces connected by the joint have no contact with the second adhesive. The consumption of adhesive can thus be reduced, which may be both an environmental and economic advantage, especially in productions of major lots of frame structures.

In a particularly appropriate embodiment, the second adhesive is applied as discrete points or strips, and in another also appropriate embodiment, it is applied with varying height. The first of these embodiments provides the largest possible material saving, whereas the second can assure a combination of material saving and hindrance of extrusion of the first adhesive. Which of these embodiments is the most appropriate depends on the actual circumstances, including the type of adhesive used, the materials used for the production of profile and plate member and the shape of the surfaces of profile and plate LS member.

In an appropriate embodiment, the first adhesive comprises silicone. After many years of usage in different branches, including windows, such adhesives have proven to be appropriate for the purpose and are further relatively inexpensive, non-toxic and inactive by contact with most of the materials used in frame structures, such as windows, doors, etc.

In a likewise appropriate embodiment, the second adhesive comprises a material based on butyl or a similar material with adhesion properties. Such adhesives require no curing and can be applied as a precise seam fitting tightly to the base. However, both the first and the second adhesive may also be known or future adhesives with the necessary properties.

In the following, the invention will be described in more detail based on an embodiment example shown on the accompanying drawing, where

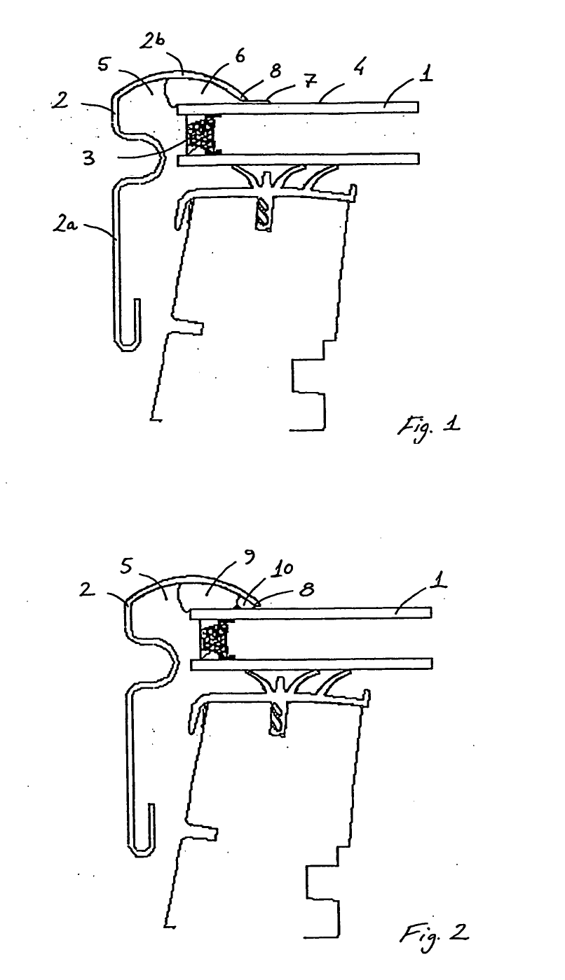

FIG. 1 shows a joint between a plate member and a frame profile produced according to prior art, and

FIG. 2 shows a joint produced by the method according to the invention and corresponding to the one shown in FIG. 1.

Both FIG. 1 and FIG. 2 show a joint between a plate member 1, here shown as a double glazing, and a frame profile 2. The frame profile 2 is shaped essentially as a reversed J, the vertical portion 2a of which covers the end border 3, whereas its curved portion 2b projects over the edge on the side 4 of the plate member which will be turned outward in the built-in condition. Below the curved portion 2b of the frame profile, a cavity 5 is provided and is limited downward by the plate member 1. The plate member may e.g. beta pane, a panel or the like.

FIG. 1 shows the joint according to prior art where a silicone seam 6 is applied in the cavity 5. At the formation of the joint, the seam 6 is, as often seen in practice, flown or smeared out, a part of the joint sealant being placed like a “tongue” 7 on the outside of the free edge 8 of the frame profile.

A joint provided according to the invention is seen in FIG. 2. Here, the cavity 5 between the plate member 1 and the frame profile 2 contains two seams 9 and 10. The second seam 10 fills the outer portion of the cavity 5 and thus acts as a barrier between the first seam 9 and the slit provided between the free edge 8 of the frame profile and the plate member 1.

A joint according to the invention is provided in the way that the first seam 9 is applied either on the plate member or on the underside of the frame profile. Subsequently, the second, smaller seam 10 is applied at the side of the first seam, and the plate member and the frame profile are brought into contact. The second seam 10 adheres immediately or perhaps after a short curing time which is preferably shorter than 10 minutes. The second seam 10 keeps the plate member 1 in place in relation to the profile 2, while the first seam 9 is curing which will generally take three to four hours, and the work may be continued with the frame structure, such as a window, a door or the like, without having to wait for the adhesive in the first seam to be cured. When in use, it is the first adhesive 9 which primarily supports the plate member 1.

The shape of the frame profile is in principle of minor importance, however, in order to protect the seams against external influence, the slit provided between the free edge 8 of the frame profile and the plate member 1 is preferably as small as possible. However, some air should normally exist between the plate member 1 and frame profile 2 in order to avoid that e.g. heat stress may result in a fracture on the plate member.

The first seam 9 can e.g. consist of a silicone-based adhesive, whereas the second seam 10 can be a so-called butyl adhesive (e.g. adhesives based on butyl, butylenes or polybutylenes). These two materials are suitable as they are workable without being liquid and furthermore meet the requirements stated above. The method according to the invention implies that in the first seam, the used adhesive can be thinner than the one used in the known method, the first seam being kept in place by the second seam.

1. A method of providing a joint between a plate member and a frame profile, where a first adhesive which obtains its bearing capacity only after a curing time, is arranged on at least one of the surfaces to be connected by the joint, such that the first adhesive in the assembled condition will be placed close to a free edge of the profile, and close to said first adhesive and between the plate member and the profile, a second adhesive is applied, said second adhesive obtaining its bearing capacity immediately or shortly after application, compared to the curing time of the first adhesive, characterized in that the second adhesive is applied between said first adhesive and the free edge of the frame profile, and said second adhesive is applied as to fit so tightly to the plate member that it prevents the first adhesive from forcing its way past the free edge thereby preventing tongues of the first adhesive on the plate member.

2. A method according to claim 1, wherein the second adhesive is provided in the form of a seam or a tape.

3. A method according to claim 1, wherein the first adhesive comprises silicone.

4. A method according to claim 1, wherein the second adhesive comprises a material based on butyl or a similar material with adhesion properties.

5. A method according to claim 1, wherein the plate member is a glass pane and the frame profile is a window frame profile.

6. A method according to claim 1, wherein the plate member is a double glazing.

7. A method according to claim 1, wherein the distance between the frame profile and the plate member is decreasing towards the free edge of the frame profile.

8. A method according to claim 1, wherein the frame profile has a curved portion providing a cavity limited downwards by the plate member.

9. A frame structure with at least one joint between a plate member and a frame profile provided by a method according to claim 1, where a first adhesive which obtains its bearing capacity only after a curing time, is arranged between plate member and profile, and close to said first adhesive, a second adhesive is applied on said profile, said second adhesive obtaining its bearing capacity immediately or shortly after application, compared to the curing time of the first adhesive, characterized in that the second adhesive is applied between said first adhesive and the free edge of the frame profile in such a way that that a sealing between the first adhesive and the free edge of the frame profile is provided.

10. A frame structure according to claim 9, wherein the distance between the frame profile and the plate member is decreasing towards the free edge of the frame profile.

11. A frame structure according to claim 9, wherein the frame profile has a curved portion.

12. A frame structure according to claim 9, wherein the second adhesive comprises a material based on butyl or a similar material with adhesion properties.

13. A frame structure accroding to claim 9 wherein the plate member is a glass pane.

14. A frame structure accroding to claim 13, wherein the glass pane is a double glazing.
